(19) United States
(12) Patent Application Publication
(10) Pub. No.: US 2016/0103602 A1
(43) Pub. Date: Apr. 14, 2016

(54) Method and system for text messaging without engaging keypad or keybord

(71) Applicants: Mohsin Shafique, Sunnyvale, CA (US); Nasir Jamal, Sunnyvale, CA (US); Syed Faizan Hasan, Sunnyvale, CA (US)

(72) Inventors: Mohsin Shafique, Sunnyvale, CA (US); Nasir Jamal, Sunnyvale, CA (US); Syed Faizan Hasan, Sunnyvale, CA (US)

(21) Appl. No.: 14/121,711

(22) Filed: Oct. 10, 2014

(51) Int. Cl. G06F 3/0488; H04L 12/58; G06F 3/0484; G06F 17/28; H04W 4/12; H04W 68/00

(52) U.S. Cl. CPC G06F 3/04883; H04W 4/12; H04W 68/005; G06F 3/04842; G06F 17/289; H04L 51/046; H04L 51/24

(57) ABSTRACT

The present invention provides a method and system for text messaging or chatting, ChatAura Application, using smart mobile and touch screen devices including laptops, and desktops without engaging the keypad or keyboard. The user writes or scribes the text message on the touch screen using her finger or a pen. The ability to write with a finger or pen on the touch screen facilitates the user when it is not feasible to focus on writing on an interface using keypad or keyboard of the device. A small keypad or keyboard may be cumbersome or inconvenient to use, especially for the elderly, or for people with disabilities who do not feel comfortable using the keypad or keyboard. The utility of the present invention extends to multiple languages and styles.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to text messaging or chatting. More particularly, the invention relates to a text messaging or chatting application, “ChatAura, which is devised for smart mobile and touch screen devices including, but not limited to, laptops and desktops. The user writes on touch screen using his/her finger or pen without engaging the keypad or keyboard of the respective device.

### BACKGROUND OF THE INVENTION

A traditional text messaging or chatting application software requires keypad or keyboard for a mobile smart device to communicate including writing, and sending the text message. In some devices the use of keypad or keyboard generally, requires the user to use both hands to conduct text messaging or chatting by selecting the recipient(s) from the chat or contact list to whom the message is intended and start writing by using the keypad or keyboard. This requires the user's full attention and may not allow the user to perform tasks including, but not limited to, driving, cooking, eating or other activities involving the use of both hands.

In traditional audio text messaging, a user records the audio message which is transformed or converted to a text format. However, challenges, including but not limited, to pronunciation, multiple languages supportability, noisy surroundings, messaging privacy, and recording accuracy are some of the key reasons that renders audio text messaging inefficient and undesirable.

Some chatting application software may be available commercially. For example, U.S. Pat. No. 8,169,462, titled: “Mobile communication device capable of storing video chatting log and operating method thereof,” teaches a mobile communication device including a radio communication unit configured to establish a video telephony call between a first user of the mobile communication device and at least a second user of another communication device. A display unit is configured to display a first image data of the first user and a second image data of the second user on the mobile communication device, and to display a chatting window on the mobile communication device when a video chatting service is selected such that the first and second users can perform a chatting operation in the chatting window, in which the first and second image data are transmitted/received through the video telephony call. A control unit configured to link chatting data displayed in the chatting window with at least one of the first image data of the first user and the second image data of the second user, and a memory unit configured to store the linked chatting data as a video chatting log.

Another prior art, U.S. Pat. No. 7,113,803, titled: “System and method for enabling instant messaging on a mobile device,” teaches a method and system for enabling instant messaging on mobile devices. A customized SMS message is created that starts the mobile device so that instant messaging may be initiated. Once the mobile device is started by the customized SMS message, the mobile device responds to the customized SMS message and initiates processing. Based on information obtained, the mobile device creates a customized reply SMS message. The reply customized SMS message is translated into a reply instant message, which is transmitted over a persistent Internet connection to the sender responsible for starting the mobile device. Alternatively, the mobile device may respond by creating an Internet connection and establishing a chat session over the Internet connection. The chat session allows the exchange of instant messages between the mobile device and the sender responsible for awakening the mobile device.

Another prior art, U.S. Pat. No. 8,694,439, titled: “Method and system for a global goal based social networking,” teaches a method and system for a Global Internet Goal based Social Networking Platform—Linkagoal. The Linkagoal provides an organized online forum for setting goals and finding solution by mutually sharing knowledge, expertise and experience with the like-minded goal oriented other Linkagoal user. The user links one or more goals and the corresponding action items on the Linkagoal platform. The user completes specific actions required to complete his goals. The Linkagoal forum is configured to have features including, but not limited to, a Linkagoal Goal Meter, a Linkagoal Chat' Aura, that further includes a Chat' Aura Integrated, a Chat' Aura Station, and a Chat' Aura Mobile.

However, there are no findings in the prior art that teach, or suggest a method and system for text messaging or chatting which is devised for mobile and touch screen devices including, but not limited to, laptops, desktops and iPods without using the keypad or keypad of the respective device. Instead of using the keypad or keyboard, the user writes on the touch screen using her finger or pen as depicted in the present invention.

Accordingly, in view of the foregoing, there is a need for a texting or chatting application which is devised for mobile and touch screen devices without using the keypad or keyboard of the respective device. The present invention fulfills the above stated need by providing ChatAura Application. It is to be noted that laptops and desktops are also equipped with touch screens where the user is able to write on the touch screen using her finger or pen.

### SUMMARY OF THE INVENTION

To achieve the forgoing and other objectives and in accordance with the purpose of the present invention, a process and system for mobile and touch screen devices including, but not limited to, laptops, desktops or iPods without using the keypad or keyboard of respective devices is presented. It is to be understood that the present invention is not limited to the particular methodology, system, techniques, uses, and applications, described herein, as these may vary. It is also to be understood that the terminology used herein is used for the purpose of describing particular embodiments only, and is not intended to limit the scope of the present invention.

In one embodiment of the present invention, a method for an exemplary sequence of the mode of action ChatAura, a texting or chatting application for smart mobile and touch screen devices including laptops, and desktops, the user is able to write a text message directly on the touch screen of the device using her finger or touch pen without using keyboard or keypad of the device. The ability to write with a finger or pen directly on the touch screen provides freedom to the user when it is not feasible to focus on writing on an interface using keyboard or keypad of the device. For example: the keypad or keyboard is relatively small and it is cumbersome or inconvenient to use, especially for the elderly, or people with disabilities who do not feel comfortable using the keypad or keyboard.

In another embodiment of the present invention, a method for an exemplary sequence of the mode of action ChatAura application may be initiated using a first voice command to the system where user may say “ChatAura” or any other given name to this command to engage or bring-up the application when the device is in certain voice range and configured in iOS or Android based mobile operating system to receive such commands. A second voice command selects the user from the contact list to whom the message is intended.

In another embodiment of the present invention, a method for an exemplary sequence of the mode of action the mobile device screen is resistive or touch screen, and the user is able to write text message on the touch screen using her finger or pen, and tap the screen twice (configurable through accessibility settings) to send or transmit the message to an intended recipient(s).

In another embodiment of the present invention, a method for an exemplary sequence of the mode of action the user is able to select and write in a plurality of languages and styles. The user is able to write in a style that will go exactly as text message to the recipient as it is written by the sender. Note: ChatAura is also equipped with an audio text messaging capability. The ChatAura is also configured to enable the user to select a texting language according to the existing location of the user.

In another embodiment of the present invention, a method for an exemplary sequence of the mode of action the user is able to write or draw sketches on the touch screen regardless of directionality of a specific language, or using a reserve screen area for accuracy.

In another embodiment of the present invention, a method for an exemplary sequence of the mode of action the touch screen device is equipped with an editing function to edit the existing text on the touch screen.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of exemplary flow chart depicting the process for ChatAura text messaging using mobile and touch screen devices including, but not limited to, laptop and desktops without engaging keypad or keyboard, in accordance with an embodiment of the present invention;

FIG. 2 is an illustration of exemplary schematic depicting the system for ChatAura text messaging using mobile and touch screen devices including, but not limited to, laptop and desktops without engaging keypad or keyboard, in accordance with an embodiment of the present invention.

### DETAILED DESCRIPTION OF THE EMBODIMENTS

The present invention is best understood by reference to the detailed figures and description set forth herein.

Embodiments of the present invention are discussed below with reference to the Figures. However, those skilled in the art will readily appreciate that the detailed description given herein with respect to these figures is for explanatory purposes as the invention extends beyond these limited embodiments. For example, it must be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

It is to be, specifically, emphasized that any teaching or combination of teachings, any novel feature, or any novel combination of features including the novel processing mechanism, or any combination of novel processing mechanisms for the ChatAura messaging process or system, in accordance with an embodiment of the present invention, is clearly distinguished form the prior art as cited above in paragraphs [8], [9], and [10], because no prior art either alone or in combination teaches all of the features of the present invention. Unlike “ChatAura,” there are no findings in the prior art that teach, or suggest a method and system for chatting , which is devised for smart mobile and touch screen devices including, but not limited to, laptops and desktops without using the keypad or keypad of the respective device as depicted in the present invention. It is further emphasized that the present invention significantly differentiates itself from the prior arts, and in particular, U.S. Pat. No. 8,694,439, titled: “Method and System for a global goal based social networking,” which teaches a method and system for a Global Internet Goal based Social Networking Platform—Linkagoal. The Linkagoal forum is configured to have Linkagoal Chat' Aura, that further includes a Chat' Aura Integrated, a Chat' Aura Station, and a Chat' Aura Mobile. However, this prior art does not teach or suggest text messaging by writing the message directly on the touch screen using a finger or pen, and thus eliminating the use of keypad or keyboard as depicted in the present invention.

To achieve the forgoing and other objectives and in accordance with the purpose of the present invention, a process and system for text messaging or chatting by writing the message directly on the touch screen of the device using a finger or pen, and thus eliminating the use of keypad or keyboard as depicted in the present invention is presented. It is to be understood that the present invention is not limited to the particular methodology, system, techniques, uses, and applications, described herein, as these may vary. It is to be understood that the terminology used herein is used for the purpose of describing particular embodiments only, and is not intended to limit the scope of the present invention.

The present invention is illustrated by way of example, and not by way of limitation, in the figures of the accompanying drawings and in which like reference numerals refer to similar elements and in which:

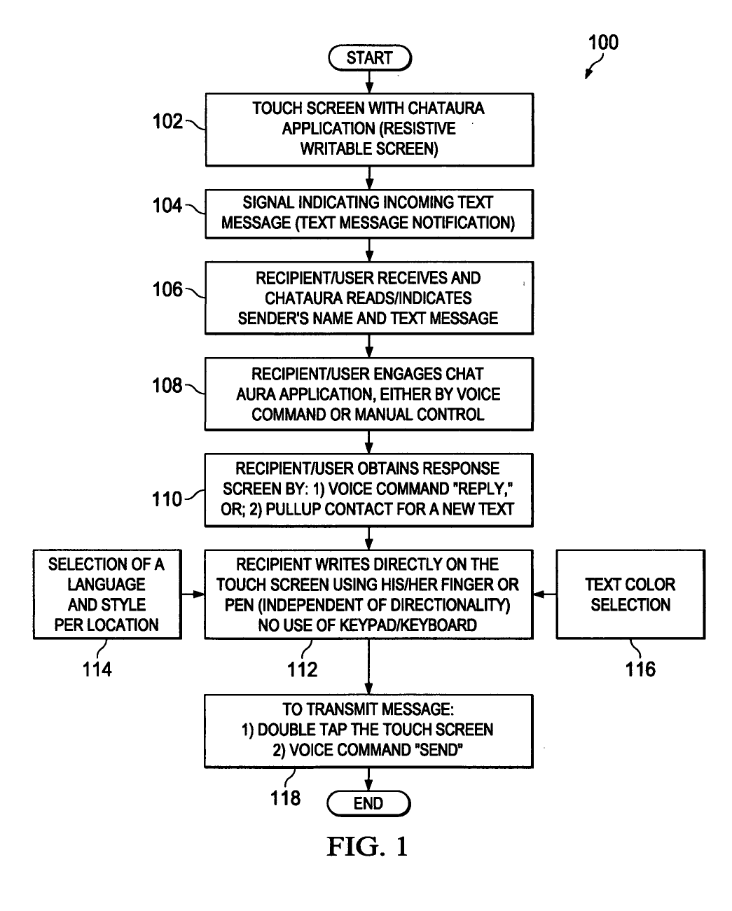

FIG. 1 is an illustration of exemplary process flow chart 100. The flow chart 100 illustrates an exemplary flow chart depicting the process for ChatAura text messaging or chatting using mobile and touch screen device 102 including, but not limited to, laptop or desktops without engaging keypad or keyboard, in accordance with an embodiment of the present invention. The user initiates the text messaging process 100 upon receiving text message notification 104. The notification 104 reads or indicates sender's name and text message 106. The user engages CharAura text messaging application 108 either by voice command, or by manual control. The user obtains response screen 110 either by voice command or pulling up a contact from the contact list for a new text message. Without engaging the keypad or keyboard, the user writes (independent of directionality) on the response screen 110 by using her finger or pen 112. The user is able to select a language and style according to existing location 114 of the user. The user is able to select color of the text or highlighting feature 116. The user transmits the completed text message 118 either by double tapping the touch screen, or by using the voice command. It is to be pointed out that hand-drawn sketches or text message is written or compiled and the completed text message 118 is transmitted without engaging the keypad or keyboard.

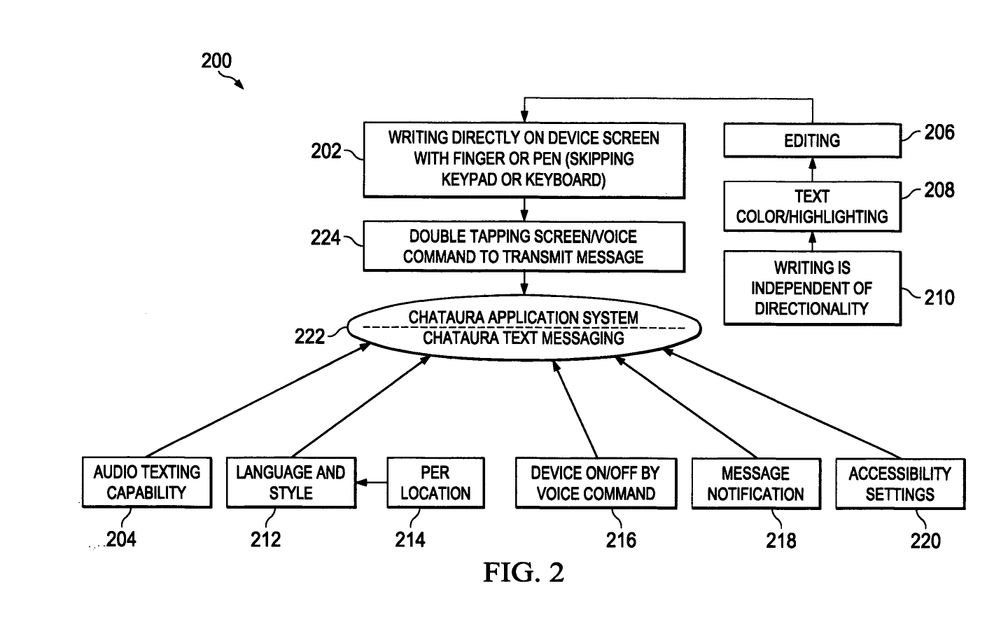

FIG. 2 is an illustration of exemplary system schematic 200. The system schematic 200 depicts the system for CharAura text messaging using mobile and touch screen device 202 (also referred as 102, in FIG. 1.) including, but not limited to, laptops and desktops without engaging the keypad or keyboard, in accordance with an embodiment of the present invention. The touch screen 202 is a resistive writable screen. The system is also equipped with an audio text messaging capability 204. The user is able to write directly on the touch screen using her finger, pen, or the audio text messaging capability 204. The system 200 is also equipped with the editing feature 206 including, but not limited to, text color and highlighting features 208. The writing on the touch screen 202 is independent of directionality 210, wherein the writer is able to write on the touch screen 202 left to right, right to left, top to bottom, bottom to top, or on any part of the touch screen 202. The user has the option to select a language or style 212. The user is also able to automatically select the language or style 212 according to the existing physical location of the user 214. For example: if the existing physical location 214 of the user is India, then the automatically selected language 212 will be Hindi, or in case of a middle eastern country, the automatically selected language 212 will be Arabic, or English in case of USA, Canada or England. The user is also able to bypass the automatically selected language 212, and select a specific language manually regardless of the location 214. Along with the manual control, the system is also equipped with ON/OFF feature using the voice command 216. Additionally, the system is also equipped with message notification 218 (104 in FIG. 1), and accessibility settings 220 features for the user's convenience standpoint (if the user has disability issues). Finally, the ChatAura Application system 222 processes and transmits the completed text message either by double tapping the touch screen 202, or by the voice command 224.

It is to be pointed out that the ChatAura text messaging or chatting application is designed or configured, without limitations, for laptops and desktops, Tablet PCs, and smart phone devices. The ChatAura is an independent text messaging or chatting Application available for popular mobile application Stores such as, but not limited to, Apple AppStore, BlackBerry Online Apps, Nokia Apps, and Andriod Apps.

Having fully described at least one embodiment of the present invention, other equivalent or alternative methods of providing a method and system for text messaging/chatting according to the present invention will be apparent to those skilled in the art. The invention has been described above by way of illustration, and the specific embodiments disclosed are not intended to limit the invention to particular forms disclosed. For example, the particular implementation of the method and system may vary depending upon a particular type of application for which it is to be used. The method and system described in the foregoing are directed to method and system for text messaging or chatting. However, similar alternatives may be used, for example; refining or improving the present invention (implementations of the present invention are contemplated as within the scope of the present invention). The invention is thus, to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

We claim:

1. A method comprising the steps of:
receiving a text message notification by a user on a smart mobile and touch screen device configured to have ChatAura Application;
engaging said ChatAura Application by said user on said smart mobile and touch screen device to reply to said text message;
commanding said smart mobile and touch screen device to read or show contents of said text message notification to said user;
obtaining response screen on said smart mobile and touch screen device to compile said reply to said text message notification by said user;
selecting at least one language from a plurality of languages to compile said reply by said user;
selecting at least one style from a plurality of styles to compile said reply by said user;
writing said reply on said response screen by said user using her finger or pen;
completing said reply on said response screen by said user; and
upon completion, transmitting said reply to a recipient by double tapping on said smart mobile and touch screen by said user.

2. The method of claim 1, wherein said ChatAura Application is a text messaging software package.

3. The method of claim 2, wherein said user is able to engage said ChatAura Application by manual control or by voice command.

4. The method of claim 3, wherein said smart mobile and touch screen device includes laptop, desktop, or iPod.

5. The method of claim 4, wherein said user is able to bypass said keypad or keyboard use by writing on said smart mobile and touch screen device by using her said finger or said pen.

6. The method of claim 5, wherein said user is able to write on said smart mobile and touch screen regardless of directionality, and wherein said directionality includes left to right, right to left, top to bottom, bottom to top or on any part of said mobile and touch screen.

7. The method of claim 6, wherein said ChatAura Application includes provisions for default settings to facilitate accessibility or disability of said user;

8. The method of claim 7, wherein said smart mobile and touch screen device includes a General Positioning System GPS, and wherein said selecting of said at least one language from said plurality of languages is automatically determined by said General Positioning System GPS by default settings according to an existing location of said smart mobile and touch screen device.

9. The method of claim 8, wherein said user is able to bypass use of said General Positioning System GPS, and wherein said selecting of said at least one language from said plurality of languages is selected manually by said user.

10. The method of claim 9, wherein said selecting of said at least one style from said plurality of styles is by default or manual by said user.

11. A system comprises:
means for receiving a text message notification by a user on a smart mobile and touch screen device configured to have ChatAura Application;
means for engaging said ChatAura Application by said user on said smart mobile and touch screen device to reply to said text message;
means for commanding said smart mobile and touch screen device to read or show contents of said text message notification to said user;
means for obtaining response screen on said smart mobile and touch screen device to compile said reply to said text message notification by said user;
means for selecting at least one language from a plurality of languages to compile said reply by said user;
means for selecting at least one style from a plurality of styles to compile said reply by said user;
means for writing said reply on said response screen by said user using her finger or pen;
means for completing said reply on said response screen by said user; and
means for transmitting said reply to a recipient by double tapping on said smart mobile and touch screen by said user.

12. The system of claim 11, in which Global Positioning System GPS is configured to said ChatAura Application as means for selecting at least one language from said plurality of languages according to an existing location of said smart mobile and touch screen device.

13. The system of claim 12, in which said ChatAura Application incorporates default settings provisions to facilitate accessibility or disability of said user.

14. The system of claim 13, in which said ChatAura Application incorporates provisions for constructing and transmitting hand-drawn sketches with hand written notes.

15. The system of claim 14, in which said ChatAura Application includes text editing and highlighting features.
